(19) United States
(12) Patent Application Publication
(10) Pub. No.: US 2017/0190552 A1
(43) Pub. Date: Jul. 6, 2017

(54) ERGONOMIC CAN OPENER AND LID REMOVER

(71) Applicant: JAMES THOMAS HARRINGTON, JR., ALACHUA, FL (US)

(72) Inventor: JAMES THOMAS HARRINGTON, JR., ALACHUA, FL (US)

(21) Appl. No.: 14/986,639

(22) Filed: Jan. 1, 2016

(51) Int. Cl. B67B 7/40

(52) U.S. Cl. CPC B67B 7/406

(57) ABSTRACT

An ergonomic can opener and lid remover, said opener having an oblong body, wherein at least one of the corners of the oblong body defines a rounded section, the oblong body has a width, a length and a height, the oblong body also defines a top and a bottom side, the oblong body further defines: a reversed L shaped opening that is defined at a section of the rounded section of the oblong body, the reversed L shaped opening is at an angle that is from about 15 to 35 degrees from the side of the oblong body defining the length of the body; at least one T shaped opening that is defined on the same side of the oblong body that defines the length of the body and that is defined on the bottom side of the body; and an oblong aperture that runs adjacent to the side of the oblong body that defines the top of the body. The ergonomic can opener and lid remover is used on cans defining a stay tab or pull tab.

### FIELD OF INVENTION

The present invention is directed to a device that will facilitate the opening of a can having a stay tab or pull tab. The present invention is also used to remove the lid of the can after the can is opened. The present invention is also directed to a tool that can be taken on an airplane as a canyon piece by people whom suffer from arthritis.

### BACKGROUND

The present invention, a stay tab opener, is of the type that uses a fulcrum type of action to open a can having a stay tab. It is designed so that it can be used on various sizes of can. It allows the user of the invention to open the can and to pull the lid of the can with the same device. The invention allows the user to open and pull the lid of the can without having to apply excessive pressure on the phalanges of the fingers. The present invention is a stay tab opener that is ergonomically designed to allow a person having diminished strength in their fingers to use the opener.

The present invention also provides a tool that can be carried on an airplane.

A stay tab is also called a pull tab. Stay tabs are used to open cans. Stay tabs are used to break a seal on either the lid of a can or an opening of a can. Once the seal is open, the stay tab, via its ring portion, can then be used to pull the lid of the can. A certain amount of force shall have to be applied to the fingers of the user when opening and pulling the lid of the can.

Stay tabs or pull tabs are more accurately defined in the following patent or patent applications. The patents or applications present tools that have been designed to facilitate the opening of cans defining a stay tab or a pull tab.

U.S. Pat. No. 5,277,083, issued to Madonia, on Jan. 11, 1994 discloses a tool for assisting people in opening pull tab actuated cans of two types. The tool is provided with structural features for engaging a pull tab ring to facilitate pivotal movement of a pull tab. The tool is also provided with structural features including a hook for engaging a pull tab ring of a pull tab to facilitate substantially linear movement of the pull tab for removing tear-away lids of cans so equipped. The tool is not designed to decrease the amount of pressure that is placed on the fingers when opening or pulling a lid of a can.

U.S. Pat. No. 5,095,777, issued to Osmar, et al., on Mar. 17, 1992 discloses a one-piece elongated body has a widened handle end portion at one end and a sharpened nose end portion at the other end. A slot extending lengthwise of the body opens generally centrally of the nose end portion. A can of the type having an opening ring attached to a lid separable from the base of the can by manipulation of the opening ring can be opened easily by use of the device by either: (1) inserting the nose of the device through the aperture of the opening ring until the ring engages in a notch adjacent to the nose portion, whereupon the device can be pulled for separating the lid from the can; or (2) sliding the device toward the opening ring such that the ring is fitted in the slot, wedging the ring upward by upward-swinging of the device, followed by turning the device such that the ring is fitted sideways in the slot and rotating the device in a screwing motion for peeling the lid from the can. The tool is not designed to decrease the amount of pressure that is placed on the fingers when opening or pulling a lid of a can.

United States Patent Application no. 20110314968, applied by Hill, on Dec. 29, 2011, discloses a pop-top can opener that includes a cavity into which the tab of a pop-top can is inserted and a lever end which allows the user to provide a leverage to the tab to open the can without the risk of damaging fingernails. A notch can be provided in the side of the device for removing the caps from bottles. The tool is not designed to decrease the amount of pressure that is placed on the fingers when opening or pulling a lid of a can.

United States Patent Application no. 20060156865, applied by Weaver, on Jul. 20, 2006, discloses a one-piece opener for food and beverage cans which employs a fulcrum type action to rupture the can seal and remove the lid of food cans or opening the drinking aperture of beverage cans. The opener is a one piece molded reinforced handle with a keyed end to hold the key tab of the can while applying an opening force using a fulcrum arm at the rim of the can. The opener is mold injected in one piece, with reinforcing webs along the length, angled surfaces at the midpoint of the handle to provided additional hand and finger contact. A slotted end is provided with a dimension that allows capture of the can key of either food or beverage cans. The opener can be produced in a variety of colors and can accommodate imprinted logos along the sides of the handle. The tool is not designed to decrease the amount of pressure that is placed on the fingers when opening or pulling a lid of a can.

There is a need for a stay tab opener that will use a fulcrum action to open a can and that will also allow the user to pull the lid of the can without having to exert an excessive amount of pressure on the phalanges of the fingers when opening or pulling the lid of the can.

### SUMMARY

The present invention provides a stay tab opener that uses a fulcrum action to open a can and that also allows the user to pull the lid of the can without having to exert an excessive amount of pressure on the phalanges of the fingers when opening or pulling the lid of the can.

An ergonomic can opener and lid remover, said opener having an oblong body, wherein at least one of the corners of the oblong body defines a rounded section, the oblong body has a width, a length and a height, the oblong body also defines a top and a bottom side, the oblong body further defines: a reversed L shaped opening that is defined at a section of the rounded section of the oblong body, the reversed L shaped opening is at an angle that is from about 15 to 35 degrees from the side of the oblong body defining the length of the body; at least one T shaped opening that is defined on the same side of the oblong body that defines the length of the body and that is defined on the bottom side of the body; and an oblong aperture that runs adjacent to the side of the oblong body that defines the top of the body. The ergonomic can opener and lid remover is used on cans defining a stay tab or pull tab.

An object of the present invention is to provide an ergonomic can opener and lid remover that can be used to open cans having a stay tab.

Another object of the present invention is to provide an ergonomic can opener and lid remover that can be used by people whom suffer from arthritis.

Yet another object of the present invention is to provide an ergonomic and monolithic can opener and lid remover that will serve to open and to remove lids of cans.

Still a further object of the present invention is to provide a tool that can be taken on an airplane as a carryon piece.

### DRAWINGS

These and other features, aspects, and advantages of the present invention will become better understood with regard to the previous description and drawings where:

FIG. 1 shows a side view of the present invention;

FIG. 2 shows a side view of another embodiment of the present invention;

FIG. 3 shows the manner in which the present invention is slid under the ring of a pull tab;

FIG. 4 shows the manner in which the present invention is used to pull the lid of a can having a pull tab; and

FIG. 5 shows anther manner in which the present invention is used to pull the lid of a can having a pull tab.

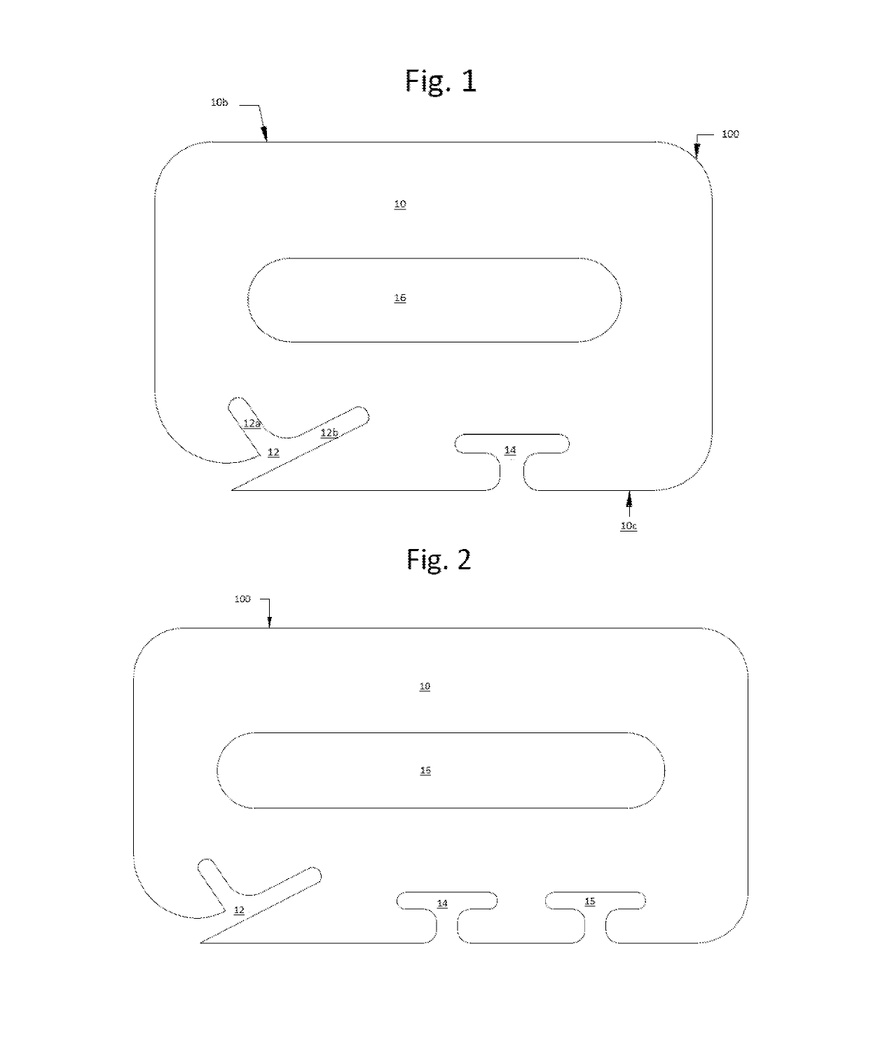

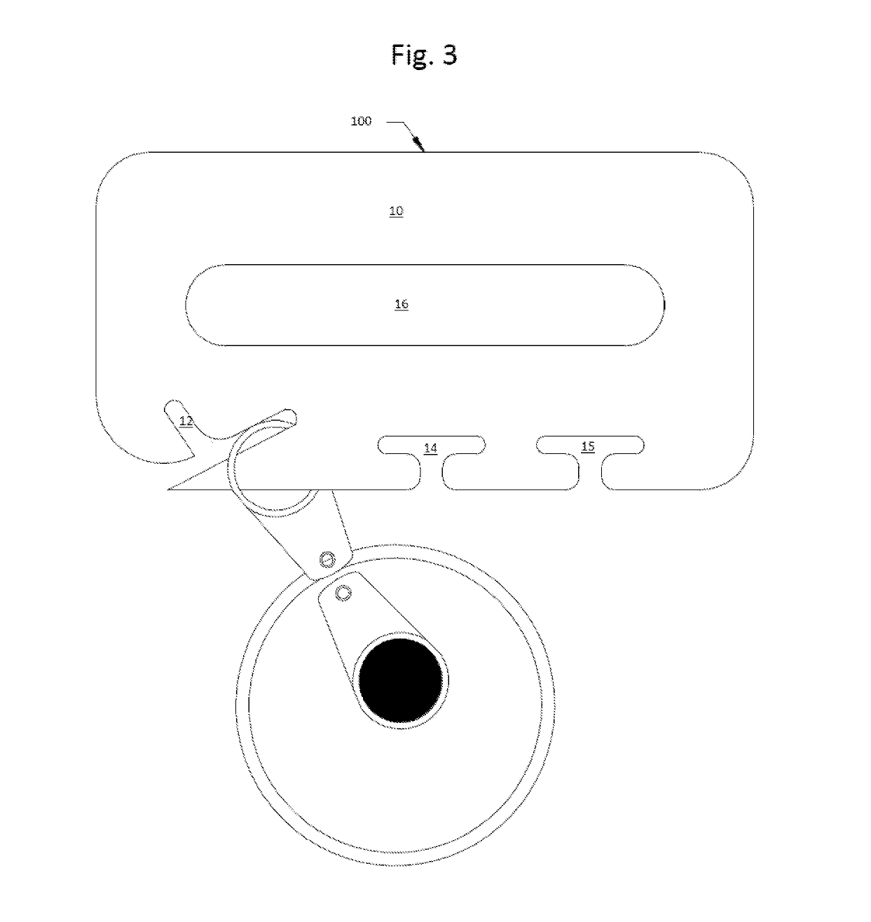

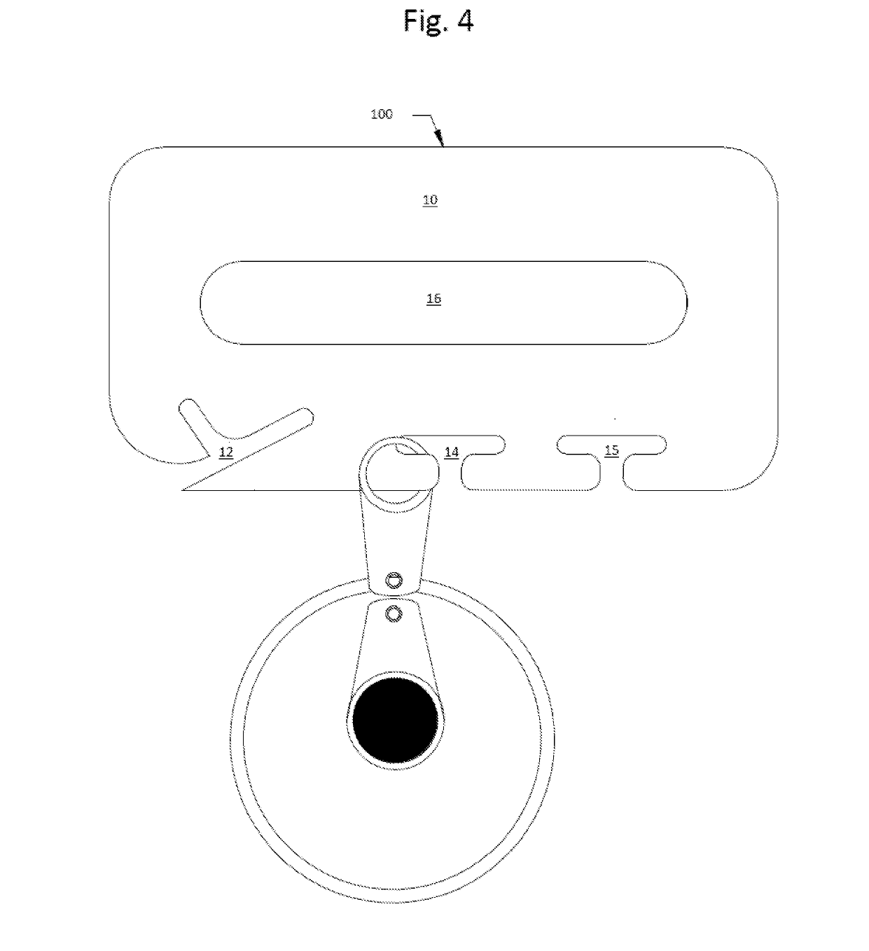

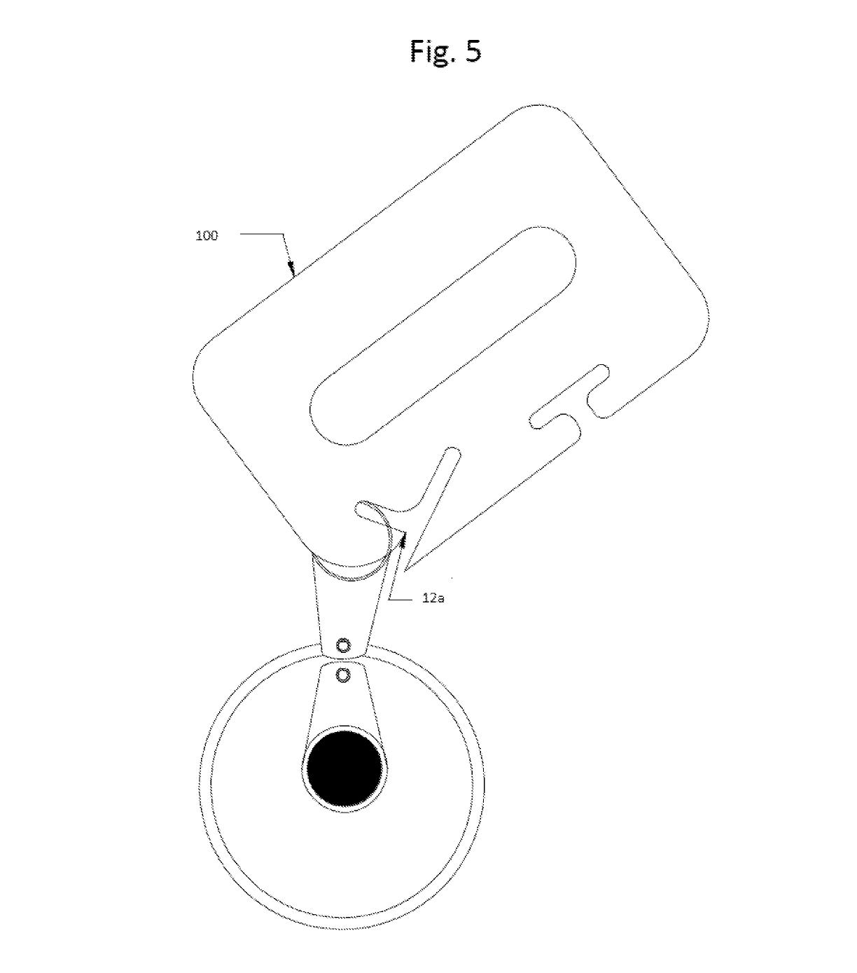

### DESCRIPTION

The present invention is an ergonomic can opener and lid remover 100. The ergonomic can opener and lid remover 100 comprises an oblong body 10, wherein at least one of the corners of the oblong body defines a rounded section 10a, the oblong body 10 has a width, a length and a height, the oblong body 10 also defines a top 10b and a bottom side 10c, the oblong body 10 further defines: a reversed L shaped opening 12 that is defined at a section of the rounded section of the oblong body, the reversed L shaped opening 12 is at an angle that is from about 15 to 35 degrees from the side of the oblong body 10 defining the length of the body 10; at least one T shaped opening 14 that is defined on the same side of the oblong body 10 that defines the length of the body 10 and that is defined on the bottom side 10c of the body 10; and an oblong aperture 16 that runs adjacent to the side of the oblong body 10 that defines the top 10b of the body 10.

In an embodiment of the present invention, a first T shaped 14 opening is defined in a middle section 10d of the bottom side of the body 10c. The T shaped opening 14 is positioned so that it can be used to apply a balanced force upwards when removing a lid.

In another embodiment the width of the body is at least half an inch. The reason for the width is that it allows the fingers of a user to rest comfortably within the aperture when manipulating the opener 100 and minimizes the chances of the opener 100 cutting the fingers of the user.

In yet another embodiment of the present invention, the length of the body is at least 5 inches. The length allows an aperture to be defined within the body 10 of the opener 100.

In still another embodiment of the present invention, the height of the body 10 is at least 2 inches. The reason for the height, is to provide the maximum ergonomic value when using the opener 100.

In a further embodiment of the present invention, the oblong aperture 16 is at least 0.5 of an inch in height and at least 3 inches in length.

In still a further embodiment of the present invention, 7 the reversed L shaped opening 12 is composed of a perpendicular branch 12a that flows from a vertical stem 12b, the branch 12a measure at least 0.3 of an inch and the stem 12b 0.6 of an inch.

In a last embodiment of the present invention, a second T shaped opening 15 is defined adjacent to the first T shaped opening 14 along the bottom side 10c of the body 10 so that it is not adjacent to the rounded section 10a defining the reversed L shaped opening 12.

To use the present invention, first a user first slides his fingers through the aperture of the oblong body so that the rounded section of the oblong body that defines the reversed L shaped opening is adjacent to the thumb of the user. Then the present invention is used by sliding the reversed L shaped opening underneath the ring of the stay tab until the tab is pushed upward, thereby opening the can. Then lastly, sliding the ring of the tab in either the branch of the reversed L shaped opening or in the arms of the T shaped opening and pulling upward. In this last step, when the user uses the branch, the user can use the rounded sections of the oblong body as a fulcrum for pulling the lid upward.

By sliding the fingers through the aperture of the oblong body, the user minimizes the force required by the fingers to manipulate the tool. This is a key aspect of the resent invention. Another key aspect of the present invention is that it is a tool that does not have any sharp element that can be used as a weapon, thereby allowing a user suffering from arthritis to take the tool in environments that restrict tools that may be characterized as weapons.

An advantage of the present invention is that it provides an ergonomic can opener and lid remover that is used to open cans that define a stay tab.

Another advantage of the present invention is that it provides an ergonomic can opener and lid remover that is used by people whom suffer from arthritis.

Yet another advantage of the present invention is that it provides an ergonomic and monolithic can opener and lid remover that serves to open and to remove lids of cans.

Still a further advantage of the present invention is that it provides a tool that can be taken on airplanes as a carryon piece.

Although the present invention has been described in considerable detail in reference to preferred versions, other versions are possible. Therefore, the spirit and scope of the present invention should not be limited to the description of the preferred versions contained herein.

What is claimed is:

1. An ergonomic can opener and lid remover, said opener comprising:
an oblong body, wherein at least one of the corners of the oblong body defines a rounded section, the oblong body has a width, a length and a height, the oblong body also defines a top and a bottom side, the oblong body further defines:
a reversed L shaped opening that is defined at a section of the rounded section of the oblong body, the reversed L shaped opening is at an angle that is from about 15 to 35 degrees from the side of the oblong body defining the length of the body;
at least one T shaped opening that is defined on the same side of the oblong body that defines the length of the body and that is defined on the bottom side of the body; and
an oblong aperture that runs adjacent to the side of the oblong body that defines the top of the body.

2. The ergonomic can opener and lid remover of claim 1, wherein a first T shaped opening is defined in a middle section of the bottom side of the body.

3. The ergonomic can opener and lid remover of claim 2, wherein the width of the body is at least half an inch.

4. The ergonomic can opener and lid remover of claim 3, wherein the length of the body is 5 inches.

5. The ergonomic can opener and lid remover of claim 4, wherein the height of the body is at least 2 inches.

6. The ergonomic can opener and lid remover of claim 5, wherein the oblong aperture is at least 0.5 of an inch in height and at least 3 inches in length.

7. The ergonomic can opener and lid remover of claim 6, wherein the reversed L shaped opening is composed of a perpendicular branch that flows from a vertical stem, the branch measure at least 0.3 of an inch and the stem 0.6 of an inch.

8. The ergonomic can opener and lid remover of claim 2, wherein a second T shaped opening is defined adjacent to the first T shaped opening along the bottom side of the body so that it is not adjacent to the rounded section defining the reversed L shaped opening.
